(19) United States
(12) Patent Application Publication
(10) Pub. No.: US 2011/0016704 A1
(43) Pub. Date: Jan. 27, 2011

(54) Method of manufacturing mini air coil

(76) Inventor: Shih-Jung Yang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,741

(22) Filed: Jul. 22, 2009

(51) Int. Cl. H01F 7/06

(52) U.S. Cl. 29/605

(57) ABSTRACT

A method of manufacturing mini air coils is revealed. Use a non-magnetic conductive line with toughness as a carrier. Wind a wire around the carrier and set the wound wire into a pattern. Then cut the wire and the carrier respectively. Thereby a mini air coil with diameter less than 0.5 mm is manufactured.

### BACKGROUND OF THE INVENTION

1. Fields of the Invention

The present invention relates to a method of manufacturing mini air coils, especially to a of manufacturing mini air coils whose diameter is less than 0.5 mm so that the mini air coils can be applied to wires with small and delicate structure.

2. Descriptions of Related Art

Refer to FIG. 1, a conventional wound coil (2) is formed by winding of cooper wires (21) whose surface is coated with an insulating enamel layer. The winding is achieved by a winding mechanism (1) shown in FIG. 2. The winding mechanism (1) includes a winding shaft (11), a bar (12) disposed on a front end of the winding shaft (11), and a cutting tool (13) arranged above the winding shaft (11). While winding the coil (2), the copper wire (21) is set on the bar (12) and then rotate the winding shaft (11) backwards so as to make the copper wire (21) wind around the bar (12) to form a spiral part. After the winding shaft (11) finishing winding, the copper wire (21) is moved from the bar (12). Then cut the copper wire by the cutting tool (13) and manufacturing of the coil (2) is now complete.

However, the above Method of manufacturing coils has certain limitations. The copper wire is wound around the bar and then is removed from the bar after finishing winding. Thus the bar needs certain strength to support the copper wire so that the diameter of the bar is no less than 0.5 mm. That means an inner diameter of the wound coil is also no less than 0.5 mm. Thus the size of the coil is restricted. This can't meet the requirement of compact design of electronic products.

Thus there is a need to develop a method of manufacturing coils whose inner diameter is no more than 0.5 mm so as to minimize coil size for being applied to electronics with compact size.

### SUMMARY OF THE INVENTION

Therefore it is a primary object of the present invention to provide a method of manufacturing mini air coils whose diameter is less than 0.5 mm so that the mini air coils can be applied to a more delicate and more compact circuit layout.

In order to achieve above object, a method of manufacturing mini air coils includes the following steps. Use a non-magnetic conductive line with toughness as a carrier. Wind a wire around the carrier and set the wound wire into a pattern. Then cut the wire and the carrier respectively. Thereby the properties of the coil will not be affected because the carrier is made from non-magnetic conductive material with toughness. Thus there is no need to take the carrier out. Moreover, the carrier will not be damaged by the winding of the wire. Therefore, a mini air coil with diameter less than 0.5 mm is manufactured.

The material of the non-magnetic conductive line is Tetoron fiber.

In the step of setting the wound wire (coil) into a pattern, the setting of the wound wire can be performed together with the winding of the wire, or after the wire being wound into the coil.

The shaping way of the coil is by hot air heating or alcohol spray.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing a wound coil available now;

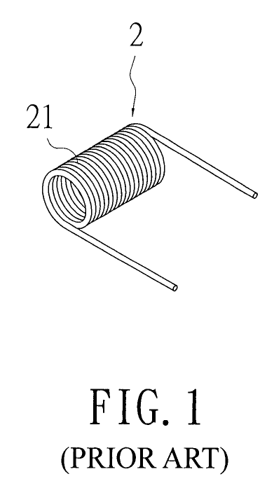

FIG. 2 is a schematic drawing showing a winding mechanism available now;

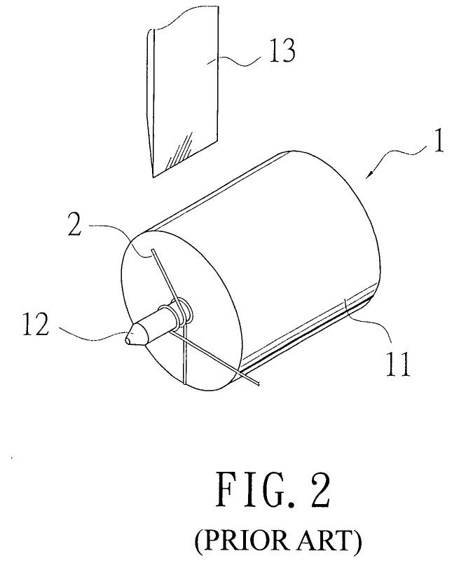

FIG. 3 is a flow chart of a method of manufacturing mini air coils according to the present invention;

FIG. 4 is a schematic drawing showing manufacturing processes of mini air coils according to the present invention;

FIG. 5 is another schematic drawing showing manufacturing processes of mini air coils according to the present invention;

FIG. 6 is a schematic drawing showing final product of mini air coils being treated with following packaging.

### DETAILED DESCRIPTION OF THE PREFERRED EMBODIMENT

The present invention discloses a method of manufacturing mini air coils that produces mini air coils with diameters less than 0.5 mm. Thus the volume of the air coils is minimized and the air coils can be applied to a circuit structure that is more compact and more delicate.

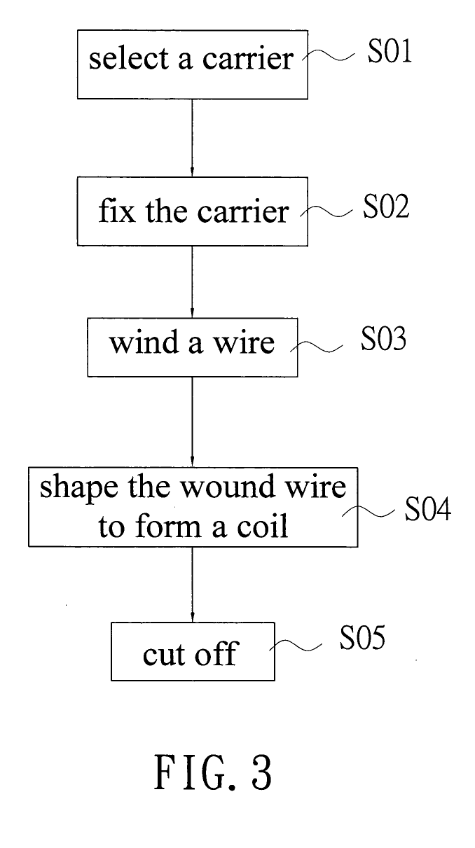

Refer from FIG. 3 to FIG. 5, a flow chart of the method of manufacturing mini air coils according to the present invention as well as each step is revealed. The method of manufacturing mini air coils includes the following steps:
step S01: select a carrier (3). The carrier (3) is anon-magnetic conductive line with toughness. The optimal material of the carrier (3) is Tetoron fiber.
step S02: fix the carrier. Fix two ends of the carrier (3) so as to make the carrier (3) become a line with tension.
step S03: wind a wire. Wind a wire (4) around the carrier (3) that is a line with tension and an insulating enamel layer is coated on a surface of the wire (4).
step S04: shape the wound wire to form a coil. Set the circular wire (4) wound around the carrier (3) into a pattern so as to form a coil.
step S05: cut off. Cut the wire (4) as well as the carrier (3) to generate a final product of the coil.

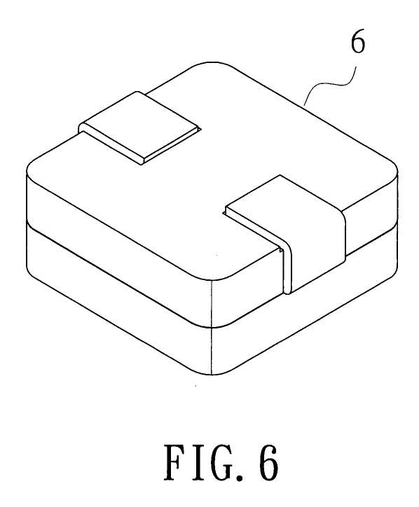

The carrier (3) is made from non-magnetic conductive line with toughness so that properties of the coil will not be affected by the carrier (3). And there is no need to take the carrier (3) out after the wire (4) being wound and set into a pattern. Moreover, the line that constitutes the carrier (3) is with toughness so that the winding of the wire (4) will not damage the carrier (3). Furthermore, the air coils produced by the present method are mini coils with diameter less than 0.5 mm that can be applied to delicate and compact circuit structures. In addition, the mini air coil can be treated by following processes such as packaging so as to form an inductor (6), as shown in FIG. 6.

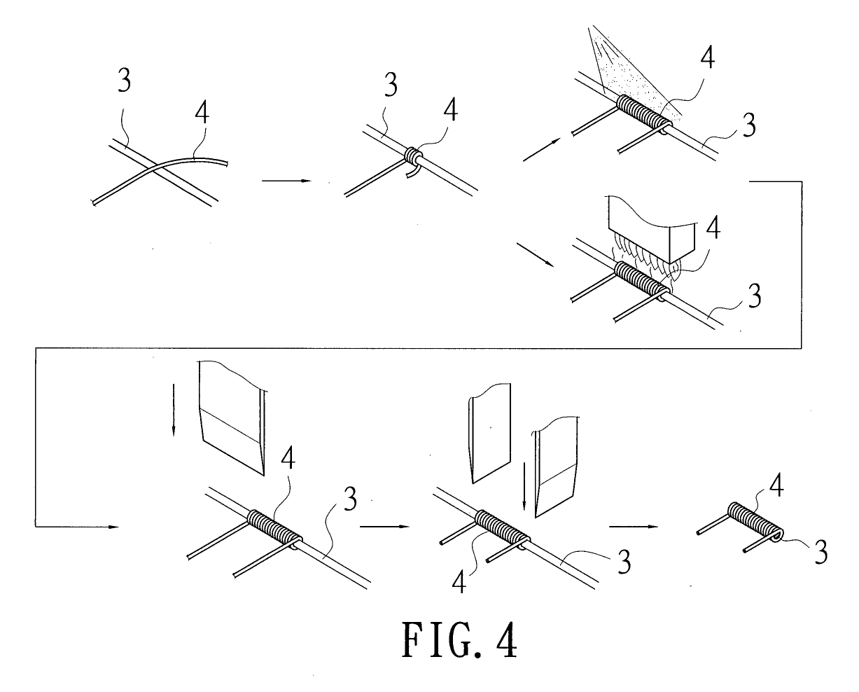

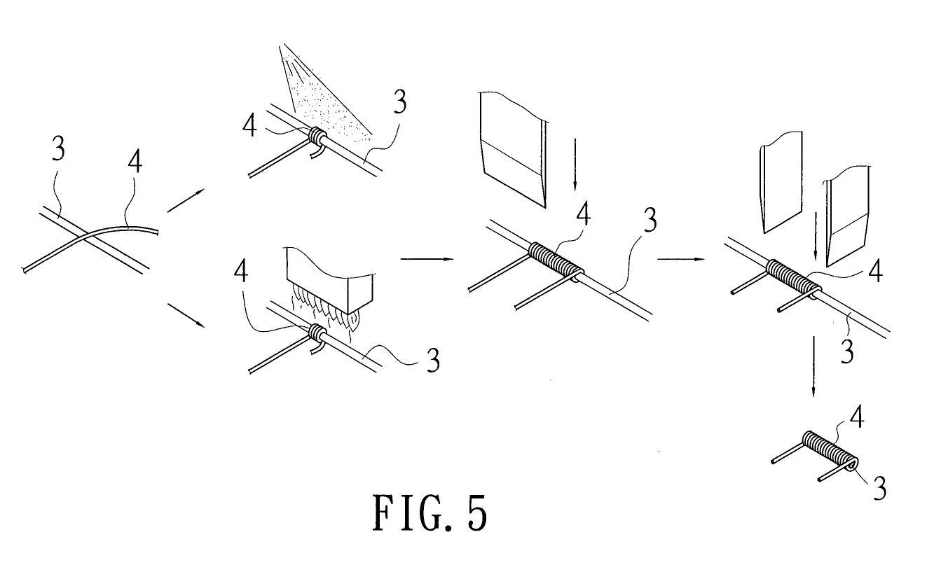

In the step of setting the circular wire (4) wound around the carrier (3) into a pattern (S04), refer to FIG. 4 and FIG. 5, the setting can be performed together with the winding of the wire (4), or after the winding of the wire (4). The setting way is by hot air heating or alcohol spray.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method of manufacturing mini air coils comprising the steps of:
a. selecting a carrier that is anon-magnetic conductive line with toughness;
b. fixing two ends of the carrier;
c. winding a wire around the carrier and the wire having an insulating enamel layer coated on a surface thereof;
d. setting the wire wound around the carrier into a pattern so as to form a coil;
e. cutting the wire and the carrier respectively to generate a final product of the coil.

2. The method as claimed in claim 1, wherein the step of setting the wire wound around the carrier into a pattern so as to form a coil is taken simultaneously with the step of winding a wire around the carrier.

3. The method as claimed in claim 1, wherein the carrier is made from Tetoron fiber.

4. The method as claimed in claim 3, wherein the step of setting the wire wound around the carrier into a pattern so as to form a coil is taken simultaneously with the step of winding a wire around the carrier.

5. The method as claimed in claim 1, wherein in the step of fixing two ends of the carrier, the carrier whose two ends are fixed becomes a line with tension.

6. The method as claimed in claim 5, wherein the step of setting the wire wound around the carrier into a pattern so as to form a coil is taken simultaneously with the step of winding a wire around the carrier.

7. The method as claimed in claim 5, wherein the step of setting the wire wound around the carrier into a pattern so as to form a coil is taken after the step of winding a wire around the carrier.

8. The method as claimed in claim 6, wherein a way of setting the wire is hot air heating or alcohol spray.
